(19) United States
(12) Patent Application Publication
(10) Pub. No.: US 2009/0073264 A1
(43) Pub. Date: Mar. 19, 2009

(54) Image signal transmission apparatus and image signal transmission system

(75) Inventor: Mitsutoshi Nagata, Obu-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/230,217

(22) Filed: Aug. 26, 2008

(30) Foreign Application Priority Data
Sep. 13, 2007 (JP) 2007-237957

(51) Int. Cl. H04N 7/18

(52) U.S. Cl. 348/148; 348/E07.085

(57) ABSTRACT

An image signal transmission system for use in a vehicle is disclosed. The system includes: a display apparatus configured to display an image in accordance with an image signal; and an image signal transmission apparatus configured to transmit the image signal to the display apparatus. The image signal transmission apparatus includes: a receiving unit configured to receive an analog image signal from outside; a conversion unit configured to convert the analog image signal into a first digital image signal so that the first digital image signal represents the image with a size that matches a display resolution of the display apparatus; and a transmission unit configured to transmit the first digital image signal to the display apparatus.

### CROSS REFERENCE TO RELATED APPLICATION

The present application is based on Japanese Patent Application No. 2007-237957 filed on Sep. 13, 2007, the disclosure of which is incorporated herein by reference.

### BACKGROUND OF THE INVENTION

1. Field of the Invention

The present invention relates to an apparatus and a system for transmitting an image signal to a display apparatus for use in a vehicle.

2. Description of Related Art

Recent vehicles have been equipped with a display apparatus that can display an image captured by a camera on a liquid crystal display panel to visualize an environment around the vehicle. Recent vehicles may further be equipped with a TV receiver so that the display apparatus displays TV pictures.

An analog format or a digital format is a format for transmitting an image signal for TV pictures or for an image captured by a camera. In a vehicle, the following technique is typically employed for image signal transmission. An analog image signal is obtained from outside. The obtained analog image signal is converted into a digital image signal, which is transmitted to a subsequent circuit or a device. The above technique is disclosed in, for example, Japanese Patent Application Publication Number 2004-304787 corresponding to U.S. Patent Application Publication Number 2004-0183916.

An international standard ITU-R BT.656 is one standard for transmitting an analog image signal as a digital format, wherein the analog image signal, for example, represents TV pictures or an image captured by a camera. The international standard ITU-R BT.656 specifies a synchronization manner by using an End of Active image (EAV) and a Start of Active image (SAV). Further, the international standard ITU-R BT.656 specifies a vertical display resolution, a bus width, and the like. The international standard ITU-R BT.656 is widely used in image signal transmission apparatuses or systems for use in a vehicle.

An analog transmission format is, for example, a composite format or a color-difference format. In the composite format, luminance formation and color information are combined into single signal. The composite format has an advantage in respect of the number of signal lines. In the color-difference format, the luminance information and the color information are separately transmitted. The color-difference format is widely used in consumer products market. The above two formats have been used in apparatuses for a vehicle.

Comparison is made below between the composite transmission and the color-difference transmission. In the composite transmission, the luminance information and the color information are combined and transmitted over single signal line. When a receiver device decodes the composite image signal, it is difficult to completely separate the luminance information and the color information.

In the composite transmission, a bandwidth is low for a display apparatus supposed to be installed into a vehicle. For example, there would be case where transmission is possible for only images having sizes less than a display resolution of the display apparatus. A horizontal display resolution is for example about 720 pixels in the composite transmission. When the display apparatus has a horizontal display resolution more than 720 pixels, for example, the horizontal display resolution of 800 pixels, it is required to perform a process for enlarging an image (e.g., a digital image) for display. The enlargement causes loss of image quality.

In the color-difference transmission, the luminance information and the color information are transmitted separately. Thus, the color-difference transmission does not have the difficulty in separating the luminance information and the color information. The color-difference transmission supports a signal for high-definition (HD) images such as 1080i, 720p, or the like. The color-difference transmission is possible to transmit image data whose image size is equal to or larger than a display resolution of the display apparatus supposed to be installed into a vehicle.

However, there is a case in 480i where the color-difference transmission can transmit only image data whose image size is less than a display resolution of the display apparatus for use in a vehicle. The above-described factor causes loss of image quality.

The followings can be other factors for image quality loss. A receiver for HD signal typically resizes or reduces a received image so that the resized image is provided with a predetermined size, and the receiver transmits the resized image. When the device in a vehicle receives the reduced image, the device resizes again the image so that a size of the image matches the display resolution of the display apparatus. Enlargement of the image such as enlargement of a digital image by resizing deteriorates the image quality. Reduction of the image by resizing may not always deteriorate the image quality but the resizing two times may cause the loss of image quality.

In respect of the resizing, the receiver for a HD signal and the device in a vehicle are redundant. That is, the system has redundancy.

An international-standard-compliant general propose system which overcomes the above difficulties may be required. In the above, discussion is given from an aspect of the analog transmission. Discussion is given below from an aspect of the digital transmission.

According to the international standard, the digital signal includes the synchronizing signals such as the EAV and the SAV. An in-vehicle environment has many noise sources such as inductive noise, power fluctuation, electrostatic discharge (ESD), or the like. The noise sources may cause the EAV or SAV to be garbled. Also, the noise sources may causes a fake EAV or a fake SAV to generate in a portion of the digital signal where the actual EAV or SAV is not supposed to be positioned. The fake EAV and the fake SAV are signal components which can be misidentified as the actual EAV and the actual SAV, respectively. The noise sources pose a possibility that a wrong synchronizing determination is made at a subsequent processing stage in the transmission path. The wrong synchronizing determination may lead to the freezing of the screen, the skipping of an image, or the like. That is, image quality is deteriorated. In the digital transmission, it may be required to perform reliable synchronization under the in-vehicle environment having many noise sources.

### SUMMARY OF THE INVENTION

In view of the above-described and other difficulties, it is an objective of the present invention to provide an image signal transmission apparatus and an image signal transmission system.

According to a first aspect of the present invention, an image signal transmission apparatus is provided. The image signal transmission apparatus is for use in a vehicle and for transmitting an image signal to a display apparatus mounted to the vehicle. The display apparatus displays an image in accordance with the image signal. The image signal transmission apparatus includes: a receiving unit configured to receive an analog image signal from outside; a conversion unit configured to convert the analog image signal into a first digital image signal so that the first digital image signal represents the image having a size that matches a display resolution of the display apparatus; and a transmission unit configured to transmit the first digital image signal to the display apparatus.

According to the above image signal transmission apparatus, it is possible to transmit to the display apparatus the first digital signal that represents the image having the size matching the display resolution of the display apparatus. In other to perform the above transmission, an additional device for resizing the size of the image for display is not necessary to be provided between the image signal transmission apparatus and the display apparatus. Therefore, it is possible to remove functional redundancy between the image signal transmission apparatus and the display apparatus. It is possible to simplify the configuration and to suppress manufacturing cost. Further, the image with a size larger than the display resolution of the display apparatus is not inputted to the display apparatus. Accordingly, the display apparatus need not to have a high-speed input port. Further, it is not necessary to resize the image multiple times. It is possible to suppress a possibility of image deterioration caused by the resizing. Accordingly, it is possible to restrict loss of the image quality and to improve the image quality. Further, according to the above image signal transmission apparatus, the analog signal is converted into the first digital signal, and the first digital signal is transmitted. The image signal transmission apparatus is compliant with the international standard, for example, ITU-R BT.656, and thus, the image signal transmission apparatus is compatible with most display apparatus. That is, the image signal transmission apparatus has versatility.

According to a second aspect of the present invention, an image signal transmission system for use in a vehicle is provided. The image signal transmission system includes: a display apparatus configured to display an image in accordance with an image signal; and an image signal transmission apparatus configured to transmit the image signal to the display apparatus. The image signal transmission apparatus includes: a receiving unit configured to receive an analog image signal from outside; a conversion unit configured to convert the analog image signal into a first digital image signal so that the first digital image signal represents the image having a size that matches a display resolution of the display apparatus; and a transmission unit configured to transmit the first digital image signal to the display apparatus.

According to the above image signal transmission system, it is possible to transmit to the display apparatus the first digital signal that represents the image with the size matching the display resolution of the display apparatus. In other to perform the above transmission, an additional device for resizing the size of the image for display is not necessary to be provided between the image signal transmission apparatus and the display apparatus. Therefore, it is possible to remove functional redundancy between the image signal transmission apparatus and the display apparatus. It is possible to simplify the configuration of the system and to suppress manufacturing cost. Further, the image with a size larger than the display resolution of the display apparatus is not inputted to the display apparatus. Accordingly, the display apparatus needs not to have a high-speed input port. Further, it is not necessary to resize the image multiple times. It is possible to suppress a possibility of image deterioration caused by the resizing. Accordingly, it is possible to restrict loss of the image quality and to improve the image quality. Further, according to the above image signal transmission apparatus, the analog signal is converted into the first digital signal, and the first digital signal is transmitted. The image signal transmission apparatus is compliant with the international standard, for example, ITU-R BT.656, and thus, the image signal transmission apparatus is compatible with most display apparatus. That is, the image signal transmission apparatus has versatility.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram illustrating an image signal transmission system in accordance with exemplary embodiments;

FIG. 2 is a block diagram illustrating functions of an LSI;

FIG. 3 is a block diagram illustrating a hardware configuration of the LSI; and

FIG. 4 is a block diagram illustrating a synchronization compensation circuit.

### DETAILED DESCRIPTION OF THE EXEMPLARY EMBODIMENTS

### Exemplary Embodiments

Exemplary embodiments are described below with reference to the accompanying drawings.

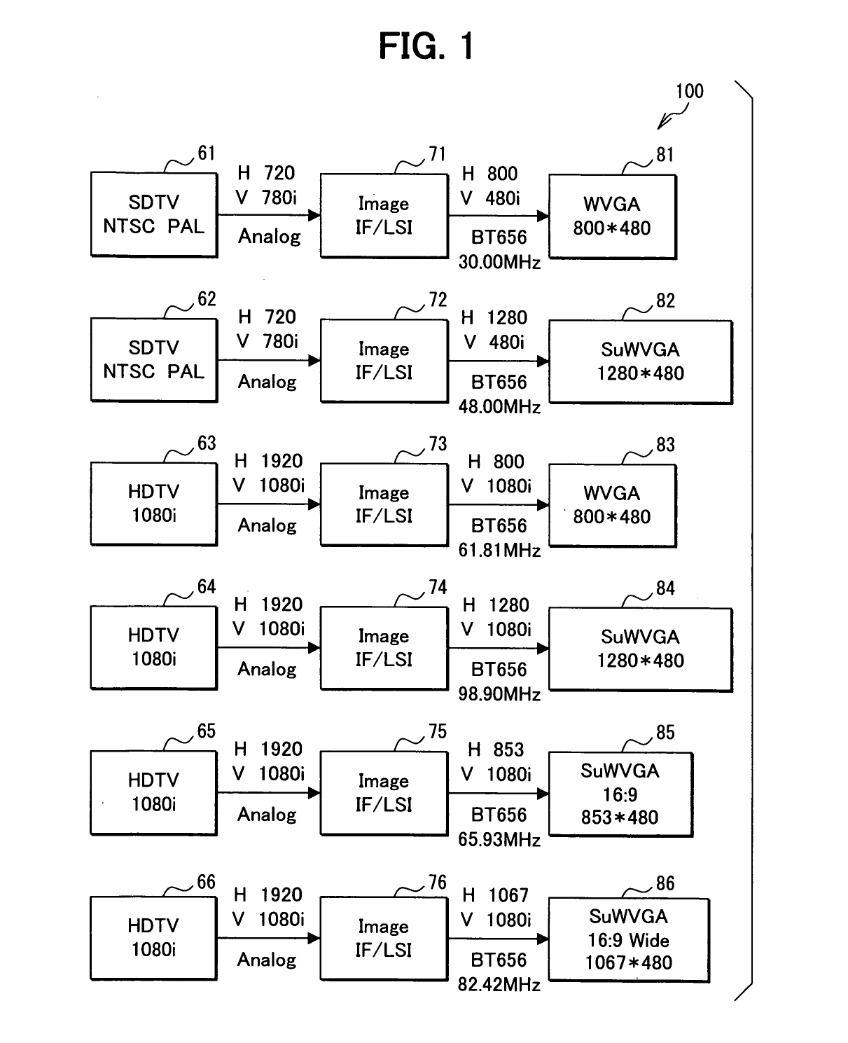

FIG. 1 is a block diagrams illustrating an image signal transmission system 100 in accordance with the exemplary embodiments.

In FIG. 1, each reference numeral 61 to 65 refers to an output source of an analog image signal. A display apparatus 81 to 86 may be an element of a navigation apparatus (not shown) for use in a vehicle.

Each display apparatus 81 to 86 is, for example, supposed to have a display resolution as shown in, for example, FIG. 1. Each of the display apparatuses 81, 83 have a display resolution of 800×480 pixels corresponding to WVGA. The display apparatuses 82, 84 have a display resolution of 1280×480 pixels corresponding to SuWVGA. The display apparatus 85 has a display resolution of 863×480 pixels corresponding to SuWVGA. The display apparatuses 82, 84 have a display resolution of 1067×480 pixels corresponding to SuWVGA.

FIG. 1 schematically illustrates image signal transmissions for Standard Definition Television (SDTV) and High Definition Television (HDTV).

The SDTV refers to a traditional television broadcast system in an aspect ratio of 4:3 and a resolution of 720×480 pixels for instance. A standard of the SDTV is, for example, National Television Standards Committee (NTSC) standard and Phase Alternation Line (PAL) standard.

The HDTV refers to a so-called high-definition television broadcast system, which enhances image quality by increasing the number of scanning lines compared with the SDTV. An image signal for SDTV and an image signal for HDTV are respectively referred to hereinafter as a SDTV image signal and an HDTV image signal.

An image interface (I/F) LSI 71 to 76, which is referred to hereinafter as an LSI, receives the SDTV image signal or the HDTV image signal from outside. The LSI 71 to 76 converts the inputted HDTV or SDTV signal into a digital image signal so that the digital image signal represents an image having a size that matches the display resolution of the display apparatus 81 to 86. The LSI 71 to 76 outputs the converted image signal to the display apparatus 81 to 86.

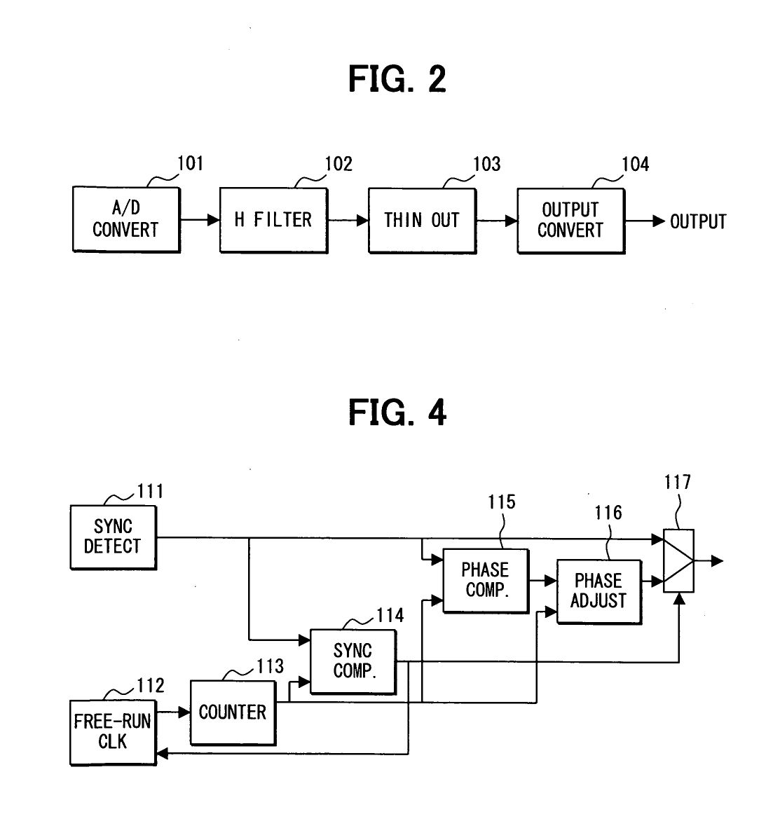

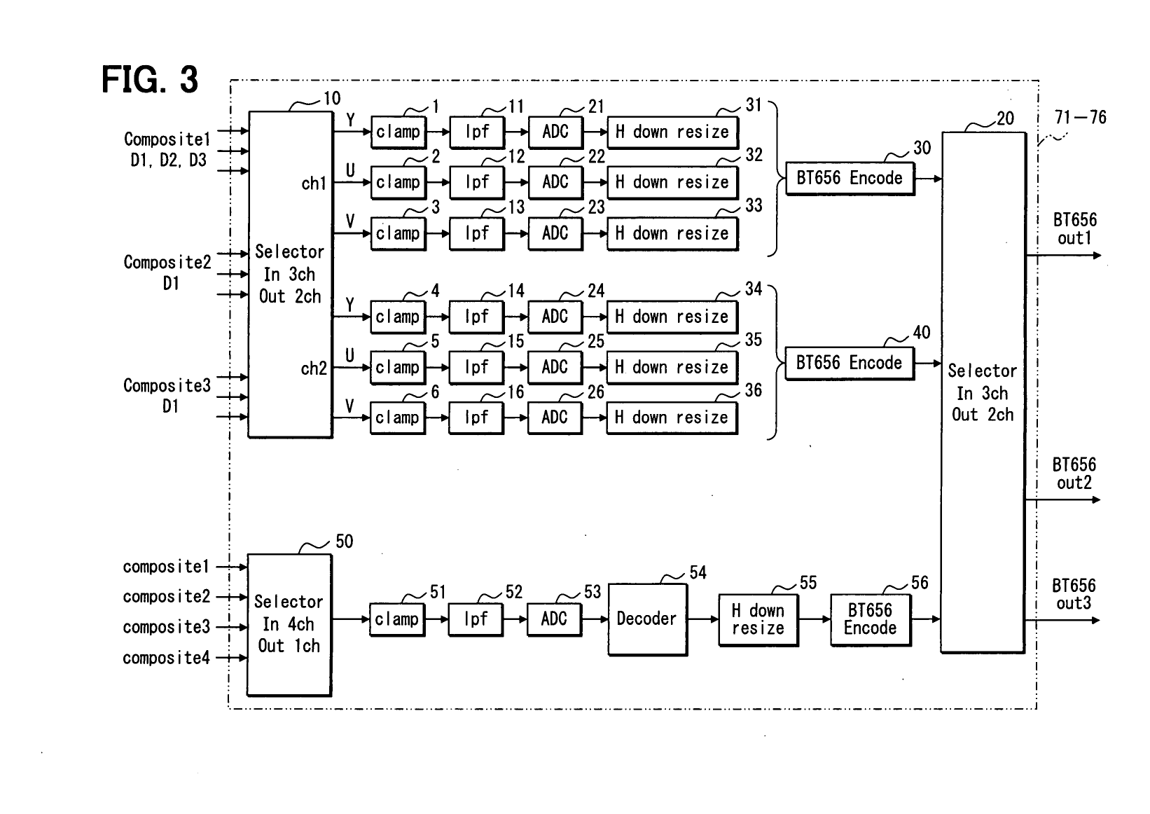

FIG. 2 is a block diagram schematically illustrating functions of each LSI 71 to 76. FIG. 3 is a block diagram schematically illustrating a hardware configuration of each LSI 71 to 76. It should be noted that the LSIs 71 to 76 have the substantially same configuration. Explanation is given on the LSI 71 below.

As shown in FIG. 2, the LSI 71 includes an analog-digital (A/D) conversion unit 101, a horizontal filter unit 102, a thinning out unit 103, and, an output conversion unit 104. An analog image signal is inputted to the A/D conversion unit 101. The A/D conversion unit 101 converts the inputted analog image signal into a digital image signal. More specifically, the analog image signal is sampled at a sampling frequency, quantized, and converted into a digital code.

The digital image signal provided by conversion in the A/D conversion unit 101 is inputted to the horizontal conversion unit 101. The horizontal filter unit 102 removes an unwanted component from a horizontal component of the digital image signal. The thinning out unit 103 thins out a horizontal component of the digital image signal so that the thinned out digital image signal represents an image having a predetermined size.

As described below, the thinned out digital image signal is a parallel signal. The output conversion unit 104 converts the thinned out digital image signal into a serial signal, and outputs the serial signal to the display apparatus 81, which performs a subsequent processing.

In FIG. 3, each of the D1, D2 and D3 refers to a standard of an image input output (I/O) terminal. In the present embodiments, the image input output (I/O) terminal is a D terminal. Regarding the D terminal, five standards D1 to D5 are defined in accordance with supporting display resolutions etc.

The D1 supports an input and output of an image signal with an image size less than or equal to 480i or 525i corresponding to the SDTV. The D1 supports a signal for interlaced display in 720×480 pixels. In the interlaced display, each frame is drawn in two-times scanning.

The D2 supports an input and output of an image signal with an image size less than or equal to 480i and 525i corresponding to the SDTV. In addition to the image signal supported by the D1, the D2 supports a signal for progressive display in 720×480 pixels. In the progressive display, each frame is drawn in single scanning.

The D3 supports an input and output of an image signal with an image size less than or equal to 1080i and 1125i corresponding to the HDTV, in addition to the image signals supported by the D1 and the D2. The D3 supports a signal for interlaced display in 1920×1080 pixels.

A color-difference transmission format is used in image signal transmission of the D1 to D3. More specifically, a luminance signal Y, a blue color-difference signal U and a red color-difference signal V are transmitted over three cables. The blue color-difference signal U has a value resulting from subtraction of a luminance component from a blue component. The red color-difference signal V has a value resulting from subtraction of a luminance component from a red component. A green color-difference signal can be calculated and obtained using the signals Y, U and V.

An input component 1 supports the D1, D2 and D3. Input components 2 and 3 support the D1. As shown in FIG. 3, the LSI 71 includes selectors 10, 20, 50, clamp circuits 1 to 6, low pass filters 11 to 16, 52, analog-digital (A/D) conversion circuits 21 to 26, 53, H down resize circuits 31 to 36, 55, a decoder 54, and BT656 encoders 30, 40, 56.

The selector 10 has three input channels and two output channels. The three input channels of the selector 10 respectively correspond to the components 1 to 3. Signals output from the selector 10 are input to the clamp circuits 1 to 6. Each clamp circuit 1 to 6 detects the synchronizing signal of the SDTV image signal or the HDTV image signal. Each clamp circuit 1 to 6 causes a minimum of an output level of the synchronizing signal to be a reference level 0, and thereby, maintains an output level of the SDTV image signal or the HDTV image signal at a constant level.

The clamp circuits 1 to 3 are used for a ch1. The clamp circuits 4 to 6 are used for a ch2. The clamp circuits 1 and 4 are used for the luminance signal Y, the clamp circuits 2 and 5 are used for the blue color-difference signal U, and the clamp circuits 3 and 6 are used for the blue color-difference signal V. As shown in FIG. 3, each low pass filter 11 to 16, each A/D conversion circuit 21 to 26, each resize circuit 31 to 36 are used for one of the luminance signal Y, the blue color-difference signal U, and the blue color-difference signal V, and used for one of the ch1 and ch2.

Signals from the clamp circuits 1 to 6 are respectively input to the low pass filters 11 to 16 through the A/D conversion circuits 21 to 26. Each low pass filter 11 to 16 removes a signal component to prevent aliasing. The aliasing is the distortion that is not included in the original analog signal.

The SDTV or HDTV image signal that has passed each low pass filter 11 to 16 is input to the corresponding A/D conversion circuit 21 to 26. The A/D conversion circuit 21 to 26 samples and quantizes the inputted SDTV or HDTV image signal at a predetermined sampling frequency, and converts the quantized signal into the digital code. More specifically, the sampling frequency in each A/D conversion circuit 21 to 26 is 27 MHz in the present embodiments. The sampling frequency of 27 MHz ensures a horizontal resolution of at least 1440 pixels. Alternatively, the sampling frequency in each A/D conversion circuit 21 to 26 may be 75 MHz. When the sampling frequency is 75 MHz, the display apparatus is supported that has the horizontal display resolution of, for example, 1920 pixels.

Each resize circuit 31 to 36 thins out the digital image signal inputted from the A/D conversion circuit 21 to 26 so that the thinned out signal represents an image with a size that matches the display resolution of the display apparatus 81 to 86.

The encoder 30 is for the 1ch and provided between the selector 20 and the resize circuits 31 to 33. The encoder 40 is for the 2ch and provided between the selector 20 and the resize circuits 34 to 36.

The encoder 30 coverts the signals from the resize circuits 31 to 33 into a signal whose format meets a standard (e.g., BT.656), and transmits the converted signal at a given transmission frequency. The encoder 40 coverts the signals from the resize circuits 34 to 36 into a signal whose format meets the standard (e.g., BT.656), and transmits the converted signal at the given transmission frequency. Also the encoder 30, 40 can adjust the given transmission frequency.

According to the present embodiments, as shown in FIG. 1, the transmission frequency is adjustable in a range between 30 MHz and about 100 MHz. When a data size for transmission is small corresponding to a case of 800×480i for instance, it is possible to perform data transmission at 30 MHz. When a data size for transmission is large corresponding to a case of 1280×1080i for instance, data transmission at 98.90 MHz may be suitable. That is, it is possible to increase the transmission frequency with increase in a data size for transmission, and thereby, it is possible to increase a transmittable data size per unit time. Thereby, it is possible to restrict an increase in a time required to complete the data transmission.

Composite signals 1 to 4 are input to the selector 50. In the composite format, the luminance information and the color information are transmitted using single signal. The selector 50 has four input channels and one output channel. That is, the selector 50 outputs one of the composite signals 1 to 4 to the clamp circuit 51.

The signal outputted from the clamp circuit 51 is input to the low pass filter 52. The signal from the low pass filter 52 is input to the A/D conversion circuit 53. The A/D conversion circuit 53 converts the signal into a digital image signal. The digital image signal is inputted to the selector 20 through the decoder 54, the resize circuit 55 and the encoder 56. The decoder 54 and the resize circuit 55 are provided with functions that are substantially identical to those of the above-described resize circuit 31 to 36.

The selector 20 has three input channels and two output channels. The selector 20 can output two signals of the signals input from the encoders 30, 40 and 56. As explained above, the A/D conversion in each LSI 76 to 76 is performed at a sufficiently large sampling frequency such as 27 MHz. In other words, the signal is over-sampled. In each LSI 76 to 76, the signal is converted so that the signal represents the image having a size greater than or equal to the largest display resolution of the display apparatuses 81 to 86. Before the image signal is output to the display apparatus 81 to 86, the image signal is thinned out in accordance with the display resolution of the target display apparatus 81 to 86, and thereby an size of the image for display is resized.

That is, the signal is over-sampled in the A/D conversion circuit 21 to 26 and compressed in the resize circuit 31 to 36. Only the above two processings substantially enable to provide the image with a size that matches the display resolution of the display apparatus 81 to 86. Accordingly, it is possible to minimize bandwidth degradation and provide the image with high quality. Further, according to the above manners, it is not necessary to enlarge a small sized image in accordance with the display resolution of the display apparatus 81 to 86. It is therefore possible to suppress loss of the image quality.

An in-vehicle environment causes characteristic impulse noise. Such impulse noise can be easily superimposed on the signal in the analog transmission path. The compression of the image signal in the resize circuit 31 to 36 leads to the compression of a noise component. Accordingly, it is possible to restrict an influence of the noise.

The image signal transmission system 100 is less redundant in respect of resizing function. It is possible to provide the image signal transmission system with a smaller whole circuit size. Therefore, it is possible to simplify a configuration of the image signal transmission system and reduce a manufacturing cost.

When the image signal that represents the resized image is transmitted to the display apparatus 81 to 86, the transmission frequency is adjusted to the data size. More specifically, when the data size is large, the transmission frequency is set to a large value. It is possible to suppress an increase in a time required for transmission.

The transmission format of the image signal transmission system 100 according to the present embodiments is compliant with the international standard ITU-R BT.656. Thus, the image signal transmission system 100 has versatility and high design freedom. A cost-cutting is expected from common product designs.

According to the present embodiments, the LSIs 71 to 76 may function as an image signal transmission apparatus. The image input output terminals D1 to D3 and the selector 10, 50 may function as a receiving unit or means. The A/D conversion circuits 21 to 26, the resize circuits 31 to 36, the A/D conversion circuit 53, the decoder 54 and the resize circuit 55 may function as a conversion unit or means. The A/D conversion circuit 21 to 26, 53 may function as an A/D conversion element or means. The resize circuits 31 to 36, 55 and the decoder 54 may function as a size adjustment element or means. The encoders 30, 40, 56 and the selector 20 may function as a transmission unit or means.

(Modifications)

The synchronization compensation circuit 120 may be provided in the transmission path between the LSI 71 to 76 and the display apparatus 81 to 86. The synchronization compensation circuit 120 is, for example, that shown in FIG. 4.

The reasons for placing the synchronization compensation circuit 120 are as follows. In the international standard BT.656-compliant transmission, the synchronizing signal for the EAV or the SAV is 1 bit signal. An in-vehicle environment has many noise sources such as inductive noise, power fluctuation, electrostatic discharge (ESD), or the like. The noise sources cause the EAV or SAV to be garbled. The noise sources also cause generation of a fake EAV or a fake SAV in a portion of the digital signal where the actual EAV or SAV is not supposed to be positioned. The fake EAV and the fake SAV are signal components which can be misidentified as the actual EAV and the actual SAV, respectively. The wrong synchronization determination may be made in a subsequent processing stage.

In the modification, the synchronization compensation circuit 120 monitors the synchronizing signal (i.e., EAV and SAV). The synchronization compensation circuit 120 generates and outputs a synchronizing signal one time or multiple times to maintains stability of the image signal transmission system 100 and to improve image quality in the display apparatus 81 to 86.

The synchronization compensation circuit 120 includes a synchronization detection element 111, a free-run clock (CLK) element 112, a counter element 113, a synchronization comparison element 114, a phase comparison element 115, a phase adjustment element 116, and an output synchronization selector element 117.

The digital image signal is input to the synchronization detection element 111. The synchronization detection element 111 separates the synchronizing signal from the inputted digital image signal. The synchronization detection element 111 outputs the separated synchronizing signal to the synchronization comparison element 114, the phase comparison element 115 and the output synchronization selector element 117. The separated synchronizing signal is referred to also as a detection synchronizing signal.

The free-run CLK element 112 generates a predetermined clock signal and outputs the clock signal to the counter element 113. The counter element 113 generates a pseudo synchronizing signal based on the inputted clock signal, and outputs the pseudo synchronizing signal to the synchronization comparison element 114, the phase comparison element 115 and the phase adjustment element 116.

The synchronization comparison element 114 compares the detection synchronizing signal from the synchronization detection element 111 and the pseudo synchronizing signal from the counter element 113. When both of the detection synchronizing signal and the pseudo synchronizing signal is in a preliminary determined range, the synchronization comparison element 114 determines that the detection synchronizing signal is proper, and outputs a predetermined control signal to the output synchronization selector element 117. The synchronization comparison element 114 generates a correction amount so that the pseudo synchronizing signal is synchronized with the detection synchronizing signal. The synchronization comparison element 114 returns a difference value, which is the correction amount, to the free-run CLK element 112, and thereby, adjusts a clock frequency generated in the free-run clock element 112.

The phase comparison element 115 detects a phase difference between the detection synchronizing signal from the synchronization detection element 111 and the pseudo synchronizing signal from the counter element 113. The phase comparison element 115 outputs to the phase adjustment element 116 a signal having a correction amount for the phase difference. The phase adjustment element 116 adjusts a phase of the pseudo synchronizing signal based on the signal having the correction amount from the phase comparison element 115. The phase adjustment element 116 outputs the adjusted pseudo synchronizing signal to the output synchronization selector element 117.

The output synchronization selector element 117 selectively outputs the detection synchronizing signal from the synchronization detection element 111 and the pseudo synchronizing signal from the counter element 113 in accordance with the control signal from the synchronization comparison element 114. According to the above configuration, even when synchronization is suddenly lost (e.g., a primary synchronizing signal is garbled), an alternative synchronizing signal is output so that synchronization determination is properly made in a subsequent processing stage.

It is therefore possible to effectively prevent pictures on the screen of the display apparatus 81 to 86 from being frozen and from jumping. It is possible to restrict loss of the image quality.

According to the present embodiments, the synchronization detection element 111 may function as a detection element or circuit. The free-run CLK element 112 and the counter element 113 may function as a pseudo synchronizing signal generation element or circuit. The synchronization comparison element 114, the phase comparison element 115 and the phase adjustment element 116 may function as a phase adjustment element or circuit. The output synchronization selector element 117 may function as a synchronizing signal selection output element or circuit.

The present embodiments also provide the image signal transmission apparatus and the image signal transmission system with the following alternative configurations. Each LSI 71 to 76 may not have the low pass filters 11 to 16, and 52. Alternatively, the number of input channels and output channels of each LSI 71 to 76 may be arbitrary.

Alternatively, the display resolution of the respective display apparatus 81 to 86 may not necessarily correspond to that illustrated in FIG. 1. Each display apparatus 81 to 86 may have another display resolution.

The disclosure described herein has the following aspects.

According to a first aspect of the disclosure, an image signal transmission apparatus is provided. The image signal transmission apparatus is for use in a vehicle and for transmitting an image signal to a display apparatus mounted to the vehicle. The display apparatus displays an image in accordance with the image signal. The image signal transmission apparatus includes: a receiving unit configured to receive an analog image signal from outside; a conversion unit configured to convert the analog image signal into a first digital image signal so that the first digital image signal provides the image with a size that matches a display resolution of the display apparatus; and a transmission unit configured to transmit the first digital image signal to the display apparatus.

According to the above image signal transmission apparatus, it is possible to transmit to the display apparatus the first digital signal that provides the image with the size matching the display resolution of the display apparatus. In other to perform the above transmission, an additional device for resizing the size of the image for display is not necessary to be provided between the image signal transmission apparatus and the display apparatus. Therefore, it is possible to remove functional redundancy between the image signal transmission apparatus and the display apparatus. It is possible to simplify the configuration and to suppress manufacturing cost. Further, the image with a size larger than the display resolution of the display apparatus is not inputted to the display apparatus. Accordingly, the display apparatus need not to have a high-speed input port. Further, it is not necessary to resize the image multiple times. It is possible to suppress a possibility of image deterioration caused by the resizing. Accordingly, it is possible to restrict loss of the image quality and to improve the image quality. Further, according to the above image signal transmission apparatus, the analog signal is converted into the first digital signal, and the first digital signal is transmitted. The image signal transmission apparatus is compliant with the international standard, for example, ITU-R BT.656, and thus, the image signal transmission apparatus is compatible with most display apparatus. That is, the image signal transmission apparatus has versatility.

Alternatively, the conversion unit may include an A/D conversion element configured to generate a second digital image signal by analog-to-digital converting the analog image signal at a predetermined sampling frequency. The second digital image signal provides the image with a size that is greater than or equal to the display resolution of the display apparatus. The conversion unit may further include a size adjustment element configured to thin out the second digital image signal by removing a predetermined component from the second digital image signal when the second digital image signal provide the image with a size that is greater than the display resolution of the display apparatus. The thinned out second image signal is the first image signal. The first digital image signal provides the image with the image size that matches the display resolution of the display apparatus.

Typically, when a size of an image is enlarged, a technique for obtaining a larger image by over-sampling an analog image signal has an advantage in the image quality over a technique for enlarging a digital image. According to the above alternative configuration of the image signal transmission apparatus, the A/D conversion element samples the analog image signal at the predetermined sampling frequency in order to obtain the image with the size larger than the display resolution of the display apparatus. In other words, the over-sampling is performed. The size adjustment element reduces the image with the larger size so that the image is provided with the size that matches the display resolution of the display apparatus. According to the above manners, it is possible to avoid loss of the image quality. That is, since it is not necessary to enlarge the digital image, it is possible prevent generation of grainy image when the digital image is enlarged.

Display apparatus mounted to a vehicle are different particularly in horizontal resolution according to the type of display apparatuses. In view of this, the image signal transmission apparatus may have the following configuration. The conversion unit may be configured to convert the analog image signal into the first digital image signal so that the first digital image signal provides the image with an horizontal image size that matches a horizontal display resolution of the display apparatus.

According to the above image signal transmission apparatus, even when the horizontal resolutions are different according to the type of display apparatuses, it is possible to transmit the digital image signal that provides the image with a size that matches the display resolution of each display apparatus. The image signal transmission apparatus supports many display apparatuses. Further, the display apparatus needs not to enlarge the image in a horizontal direction. Therefore, it is possible to restrict loss of the image quality and to improve the image quality.

Alternatively, the transmission unit may be configured to change, in accordance with an amount of data of the first digital image signal, a transmission frequency for transmitting the first image signal, and transmits the first digital image signal.

In the above image signal transmission apparatus, the transmission frequency may increase with an increase in the data amount of the digital image signal. When the digital image signal is generated for providing an image with a size that matches a large display resolution of a display apparatus, the digital image has a large data amount. In the above case, a large transmission frequency restricts an increase in time required for data transmission. The display apparatus can display the image or video reliably and smoothly. Therefore, it is possible to improve the image quality.

According to a second aspect of the present invention, an image signal transmission system for use in a vehicle is provided. The image signal transmission system includes: a display apparatus configured to display an image in accordance with an image signal; and an image signal transmission apparatus configured to transmit the image signal to the display apparatus. The image signal transmission apparatus includes: a receiving unit configured to receive an analog image signal from outside; a conversion unit configured to convert the analog image signal into a first digital image signal so that the first digital image signal provides the image with a size that matches a display resolution of the display apparatus; and a transmission unit configured to transmit the first digital image signal to the display apparatus.

According to the above image signal transmission system, it is possible to transmit to the display apparatus the first digital signal that provides the image with the size matching the display resolution of the display apparatus. In other to perform the above transmission, an additional device for resizing the size of the image for display is not necessary to be provided between the image signal transmission apparatus and the display apparatus. Therefore, it is possible to remove functional redundancy between the image signal transmission apparatus and the display apparatus. It is possible to simplify the configuration of the system and to suppress manufacturing cost. Further, the image with a size larger than the display resolution of the display apparatus is not inputted to the display apparatus. Accordingly, the display apparatus needs not to have a high-speed input port. Further, it is not necessary to resize the image multiple times. It is possible to suppress a possibility of image deterioration caused by the resizing. Accordingly, it is possible to restrict loss of the image quality and to improve the image quality. Further, according to the above image signal transmission apparatus, the analog signal is converted into the first digital signal, and the first digital signal is transmitted. The image signal transmission apparatus is compliant with the international standard, for example, ITU-R BT.656, and thus, the image signal transmission apparatus is compatible with most display apparatus. That is, the image signal transmission apparatus has versatility.

Alternatively, the conversion unit may include an A/D conversion element configured to generate a second digital image signal by analog-to-digital converting the analog image signal at a predetermined sampling frequency. The second digital image signal provides the image with a size that is greater or equal to the display resolution of the display apparatus. The conversion unit may further include a size adjustment element configured to thin out the second digital image signal by removing a predetermined component from the second digital image signal when the second digital image signal provides the image with a size that is greater than the display resolution of the display apparatus. The thinned out second image signal is the first image signal. The first digital image signal provides the image with the image size that matches the display resolution of the display apparatus.

According to the above configuration of the image signal transmission system, the A/D conversion element samples the analog image signal at the predetermined sampling frequency in order to obtain the image with the size larger than the display resolution of the display apparatus. In other words, the over-sampling is performed. The size adjustment element reduces the image with the larger size so that the image is provided with the size that matches the display resolution of the display apparatus. According to the above manners, it is possible to avoid loss of the image quality. That is, since it is not necessary to enlarge the digital image, it is possible prevent generation of grainy image when the digital image is enlarged.

Alternatively, the conversion unit may be configured to convert the analog image signal into the first digital image signal so that the first digital image signal provides the image with an horizontal image size that matches a horizontal display resolution of the display apparatus.

According to the above image signal transmission system, even when the horizontal resolutions are different according to the type of display apparatuses, it is possible to transmit the digital image signal that provides the image with a size that matches the display resolution of each display apparatus. The image signal transmission apparatus supports many display apparatuses. Further, the display apparatus needs not to enlarge the image in a horizontal direction. Therefore, it is possible to restrict loss of the image quality and to improve the image quality.

Alternatively, the transmission unit may be configured to change, in accordance with an amount of data of the first digital image signal, a transmission frequency for transmitting the first image signal, and transmits the first digital image signal.

According to the above image signal transmission system, the transmission frequency may increase with an increase in the data amount of the digital image signal. When the digital image signal is generated for providing an image with a size that matches a large display resolution of a display apparatus, the digital image has a large data amount. In the above case, a large transmission frequency restricts an increase in time required for data transmission. The display apparatus can display the image or video reliably and smoothly. Therefore, it is possible to improve the image quality.

Alternatively, the above image signal transmission system may further include a synchronization compensation unit provided in a transmission path for transmitting the first image signal from the image signal transmission apparatus to the display apparatus. The first digital image signal includes a synchronizing signal for synchronizing a display timing. The synchronization compensation circuit compensates the synchronizing signal.

According to the above image signal transmission system, the synchronizing signal may be, for example, the EAV signal or the SAV signal. Each of the EAV signal and the SAV signal is 1 bit signal. The in-vehicle environment has many noise sources. The noise sources may cause the EAV or the SAV to be garbled. The noise sources also may cause generation of a signal component in the digital image signal, the signal component that can be misidentified as the EAV or the SAV and that is located in a portion of the digital signal where the EAV or the SAV is not supposed to be positioned. The above image signal transmission system includes the synchronization compensation circuit configured to compensate the synchronizing signal. In the above, “compensation” may mean proper generation of the EAV or SAV. In concrete terms, “compensation” means that, even when the EAV or the SAV is garbled, an alternative proper synchronizing signal that is a substitute for the garbled EAV or SAV is output. According to the above system having the synchronizing compensation circuit, it is possible to restrict an occurrence of an error in a synchronization determination performed in a subsequent processing stage of the transmission path. Freezing or skipping caused by an error in the synchronization determination is restricted. It is possible to prevent a decrease in the image quality.

The above image signal transmission system may be configured to as follows. The synchronization compensation unit includes a detection element configured to detect the synchronizing signal in the first digital signal and remove the synchronizing signal from the first digital signal. The detected synchronizing signal is a detection synchronizing signal. The synchronization compensation unit further includes a pseudo synchronizing signal generation element configured to generate a pseudo synchronizing signal; a phase adjustment element configured to adjust a phase of the pseudo synchronizing signal based on a phase difference between the detection synchronizing signal and the pseudo synchronizing signal; and a synchronizing signal selection output element configured to compare between the detection synchronizing signal and the phase-adjusted pseudo synchronizing signal. The synchronizing signal selection output element is configured to incorporate the detection synchronizing signal into the first digital image signal when the phase difference between the detection synchronizing signal and phase-adjusted pseudo synchronizing signal is in a predetermined range. The synchronizing signal selection output element is configured to incorporate the phase-adjusted pseudo synchronizing signal into the first digital image signal when the phase difference between the detection pseudo synchronizing signal and phase-adjusted pseudo synchronizing signal is not in the predetermined range.

According to the above system, when a primary synchronizing signal (i.e., detection synchronizing signal) is garbled, an alternative synchronizing signal (i.e., pseudo synchronizing signal) is output at least one time. Accordingly, it is possible to prevent a decrease in the image quality.

While the invention has been described above with reference to various embodiments thereof, it is to be understood that the invention is not limited to the above described embodiments and construction. The invention is intended to cover various modification and equivalent arrangements. In addition, while the various combinations and configurations described above are contemplated as embodying the invention, other combinations and configurations, including more, less or only a single element, are also contemplated as being within the scope of embodiment.

What is claimed is:

1. An apparatus for use in a vehicle and for transmitting an image signal to a display apparatus mounted to the vehicle, the display apparatus displaying an image represented by the image signal, the apparatus comprising:
a receiving unit configured to receive an analog image signal from outside;
a conversion unit configured to convert the analog image signal into a first digital image signal, wherein the first digital image signal represents the image having a size that matches a display resolution of the display apparatus; and
a transmission unit configured to transmit the first digital image signal to the display apparatus.

2. The apparatus according to claim 1, wherein
the conversion unit includes:
an A/D conversion element configured to generate a second digital image signal by analog-to-digital converting the analog image signal at a predetermined sampling frequency, wherein the second digital image signal represents the image having a size that is greater than or equal to the display resolution of the display apparatus; and
a size adjustment element configured to thin out the second digital image signal by removing a predetermined component from the second digital image signal when the second digital image signal represents the image having a size that is greater than the display resolution of the display apparatus, wherein the thinned out second image signal is the first image signal.

3. The apparatus according to claim 1, wherein
the conversion unit is configured to convert the analog image signal into the first digital image signal, wherein the first digital image signal represents the image having an horizontal image size that matches a horizontal display resolution of the display apparatus.

4. The apparatus according to claim 1, wherein
the transmission unit is configured to transmits the first digital image signal while changing a transmission frequency for transmitting the first image signal in accordance with an amount of data of the first digital image signal.

5. A system for use in a vehicle, comprising:
a display apparatus configured to display an image represented by an image signal; and
an image signal transmission apparatus configured to transmit the image signal to the display apparatus, wherein image signal transmission apparatus includes:
a receiving unit configured to receive an analog image signal from outside;
a conversion unit configured to convert the analog image signal into a first digital image signal, wherein the first digital image signal represents the image having a size that matches a display resolution of the display apparatus; and
a transmission unit configured to transmit the first digital image signal to the display apparatus.

6. The system according to claim 5, wherein
the conversion unit includes:
an A/D conversion element configured to generate a second digital image signal by analog-to-digital converting the analog image signal at a predetermined sampling frequency, wherein the second digital image signal represents the image having a size that is greater or equal to the display resolution of the display apparatus; and
a size adjustment element configured to thin out the second digital image signal by removing a predetermined component from the second digital image signal when the second digital image signal represents the image having a size that is greater than the display resolution of the display apparatus, wherein the thinned out second image signal is the first image signal.

7. The system according to claim 5, wherein
the conversion unit is configured to convert the analog image signal into the first digital image signal so that the first digital image signal represents the image having a horizontal size that matches a horizontal resolution of the display apparatus.

8. The system according to claim 5, wherein
the transmission unit is configured to change, in accordance with a data amount of the first digital image signal, a transmission frequency for transmitting the first image signal, and transmits the first digital image signal.

9. The system according to claim 6, further comprising:
a synchronization compensation unit provided in a transmission path for transmitting the first image signal from the image signal transmission apparatus to the display apparatus, wherein:
the first digital image signal includes a synchronizing signal for synchronizing a display timing; and
the synchronization compensation circuit compensates the synchronizing signal.

10. The system according to claim 9, wherein
the synchronization compensation unit includes:
a detection element configured to detect the synchronizing signal in the first digital signal and remove the synchronizing signal from the first digital signal, wherein the detected synchronizing signal is a detection synchronizing signal;
a pseudo synchronizing signal generation element configured to generate a pseudo synchronizing signal;
a phase adjustment element configured to adjust a phase of the pseudo synchronizing signal based on a phase difference between the detection synchronizing signal and the pseudo synchronizing signal; and
a synchronizing signal selection output element configured to compare between the detection synchronizing signal and the phase-adjusted pseudo synchronizing signal,
wherein the synchronizing signal selection output element is configured to incorporate the detection synchronizing signal into the first digital image signal when the phase difference between the detection synchronizing signal and phase-adjusted pseudo synchronizing signal is in a predetermined range,
wherein the synchronizing signal selection output element is configured to incorporate the phase-adjusted pseudo synchronizing signal into the first digital image signal when the phase difference between the detection pseudo synchronizing signal and phase-adjusted pseudo synchronizing signal is not in the predetermined range.

11. The system according to claim 5, wherein
the image signal transmission apparatus is provided by an image I/F LSI.
